(19) United States
(12) Patent Application Publication
(10) Pub. No.: US 2023/0125357 A1
(43) Pub. Date: Apr. 27, 2023

(54) LASER MACHINING APPARATUS

(71) Applicant: Mitsubishi Electric Corporation, Tokyo (JP)

(72) Inventors: Masato KAWASAKI, Tokyo (JP); Tomotaka KATSURA, Tokyo (JP)

(73) Assignee: Mitsubishi Electric Corporation, Tokyo (JP)

(21) Appl. No.: 17/914,764

(22) PCT Filed: May 11, 2020
(86) PCT No.: PCT/JP2020/018865

§ 371 Date: Sep. 27, 2022

(51) Int. Cl. B23K 26/064; B23K 26/06; B23K 26/38

(52) U.S. Cl. CPC B23K 26/064; B23K 26/0604; B23K 26/38

(57) ABSTRACT

A laser machining apparatus includes an output ratio control unit that changes an output ratio between a first laser beam and a second laser beam having different propagation characteristics; a superimposing optical system that multiplexes the first laser beam and the second laser beam; an optical fiber in which beam propagation characteristics of a combined laser beam at an exit varies depending on the output ratio, the combined laser beam being a laser beam obtained by combination of the first laser beam and the second laser beam; and a condensing optical system that performs machining of a workpiece by concentrating, on the workpiece, the beam emitted from the optical fiber.

### FIELD

The present disclosure relates to a laser machining apparatus including a mechanism for modulating beam quality.

### BACKGROUND

In a conventional laser machining apparatus, the beam quality, a beam profile, and the like of a laser beam to be emitted from an optical fiber are modulated by the changing of the position or angle of entry of a laser beam into the optical fiber (for example, Patent Literature 1).

### CITATION LIST

### Patent Literature

Patent Literature 1: Japanese Translation of PCT International Application Laid-open No. 2015-500571

### SUMMARY

### Technical Problem

In such a laser machining apparatus, it is necessary to move an optical element, a light source, and the like for modulating the beam quality of a laser beam to be emitted from a fiber, and there are problems such as complication of the apparatus caused by a drive system and deterioration of stability of the installation position of each component.

The present disclosure has been made in view of the above, and an object of the present disclosure is to obtain a laser machining apparatus capable of controlling beam quality of a laser beam without driving an optical element and a machine component, and achieving modulation of the beam quality relatively inexpensively and stably.

### Solution to Problem

In order to solve the above problem and achieve the object, a laser machining apparatus according to this disclosure includes: a first laser light source to generate a first laser beam; a second laser light source to generate a second laser beam having propagation characteristics different from propagation characteristics of the first laser beam; an output ratio control unit to change an output ratio that is a ratio between an output of the first laser beam and an output of the second laser beam; a multiplexing optical system to multiplex the first laser beam and the second laser beam; an optical fiber including a core and a cladding, the optical fiber having an entrance and an exit, the first laser beam and the second laser beam being input to the entrance after passing through the multiplexing optical system, the first laser beam and the second laser beam being emitted from the exit, beam propagation characteristics of a combined laser beam at the exit varying depending on the output ratio, the combined laser beam being a laser beam obtained by combination of the first laser beam and the second laser beam; and a condensing optical system to perform machining of a workpiece by concentrating, on the workpiece, the beam emitted from the optical fiber.

### Advantageous Effects of Invention

The present disclosure achieves the effect of enabling beam quality of a laser beam to be controlled without driving an optical element and a machine component, and enabling the beam quality to be modulated relatively inexpensively and stably.

### BRIEF DESCRIPTION OF DRAWINGS

FIG. 1 is a configuration diagram illustrating a laser machining apparatus according to a first embodiment.

FIG. 2 is a diagram illustrating intensity distributions of laser beams that enter an optical fiber in the first embodiment.

FIG. 3 is a diagram illustrating an intensity distribution of an outgoing laser beam from the optical fiber in the first embodiment.

FIG. 4 is a configuration diagram showing an example of a superimposing optical system in the first embodiment.

FIG. 5 is a configuration diagram showing an example of the superimposing optical system in the first embodiment.

FIG. 6 is a configuration diagram illustrating a laser machining apparatus according to a second embodiment.

FIG. 7 is a configuration diagram illustrating a learning device according to the second embodiment.

FIG. 8 is a conceptual diagram illustrating a learning method in the second embodiment.

FIG. 9 is a process drawing illustrating a learning procedure in the second embodiment.

FIG. 10 is a configuration diagram illustrating an inference device according to the second embodiment.

FIG. 11 is a process drawing illustrating a processing procedure in the second embodiment.

### DESCRIPTION OF EMBODIMENTS

Hereinafter, a laser machining apparatus according to each embodiment of the present disclosure will be described in detail with reference to the drawings.

### First Embodiment

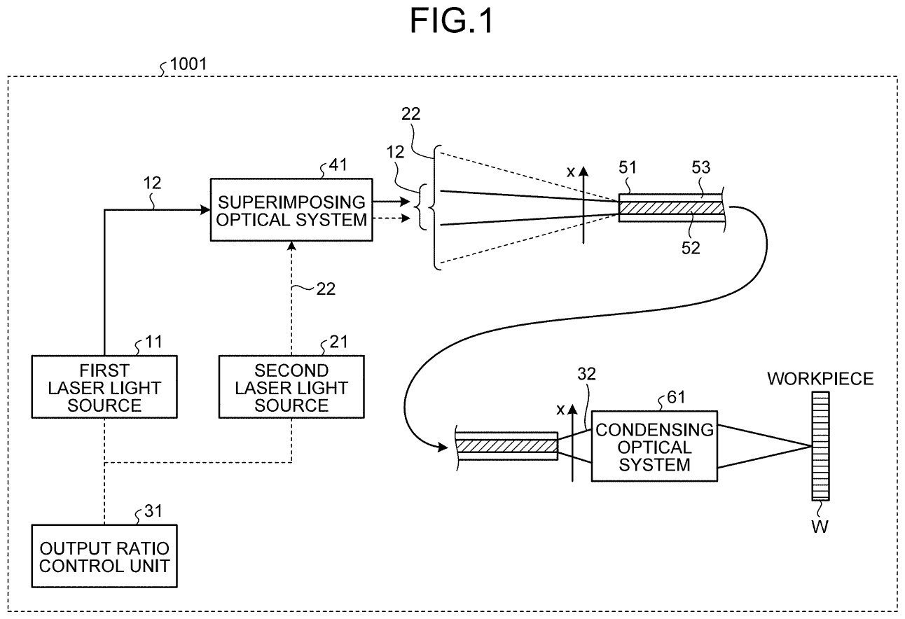

FIG. 1 is a schematic diagram illustrating a configuration of a laser machining apparatus 1001 according to a first embodiment. The laser machining apparatus 1001 includes a first laser light source 11, a second laser light source 21, an output ratio control unit 31, a superimposing optical system 41, an optical fiber 51, and a condensing optical system 61. The first laser light source 11 generates a laser beam 12 as a first laser beam. The second laser light source 21 generates a laser beam 22 as a second laser beam. The output ratio control unit 31 controls an output ratio that is a ratio between an output of the laser beam 12 and an output of the laser beam 22. The superimposing optical system 41 is for superimposing the laser beam 12 and the laser beam 22. The optical fiber 51 receives the superimposed beams. The condensing optical system 61 concentrates an outgoing laser beam 32 from the optical fiber 51 on a workpiece W. It can also be said that the superimposing optical system 41 is a multiplexing optical system that multiplexes the laser beam 12 and the laser beam 22.

In the first embodiment, the optical fiber 51 includes a single core 52 and a single cladding 53. The core 52 transmits light having entered the optical fiber 51. The cladding 53 has a role of confining the light in the core 52.

It is known that when entry of a laser beam into an optical fiber is compared with emission of the laser beam from the optical fiber in transmission of the laser beam, through the optical fiber, the divergence angle of the outgoing beam is substantially equal to the converging angle of the incoming beam, and an output-end face beam radius that is a beam radius on an output end face is substantially equal to the radius of the core of the optical fiber.

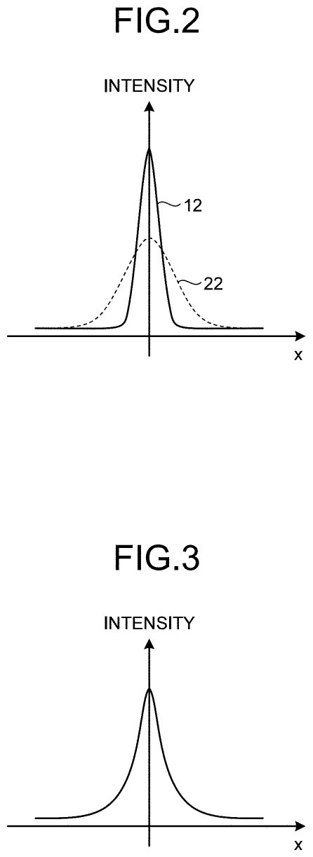

In the first embodiment, the laser beam 12 and the laser beam 22 have different propagation characteristics. FIG. 2 illustrates beam intensity distributions of the laser beam 12 and the laser beam 22 that enter the optical fiber 51. FIG. 3 illustrates an intensity distribution of the laser beam 32 as a combined laser beam to be emitted from the optical fiber 51. An x-direction indicates any given direction on a plane perpendicular to the axis of the laser beam. The laser beam 12 and the laser beam 22 enter the optical fiber 51 such that at least one of the converging angle of the beam that enters the optical fiber 51 and the input-end face beam radius of the optical fiber 51 differs between the laser beam 12 and the laser beam 22. The example shown in FIG. 1 is based on the assumption that the converging angle of the laser beam 22 entering the optical fiber 51 is equal to or larger than the converging angle of the laser beam 12 entering the optical fiber 51, and the input-end face beam radius of the laser beam 22 is equal to or smaller than the input-end face beam radius of the laser beam 12.

The beam quality of a laser beam to be emitted from an optical fiber is represented by a beam parameter product. Hereinafter, the beam parameter product is referred to as BPP. The BPP is expressed as follows: BPP=output-end face beam radius×divergence half angle (mm·mrad) of outgoing laser beam. That is, the BPP is the product of the output-end face beam radius of the optical fiber and the divergence half angle of the outgoing laser beam.

The smaller the value of the BPP, the better the beans quality, that is, the higher the light condensing properties. In order to minimize deterioration of beam quality due to fiber light guiding in the entry of a laser beam into an optical fiber, the laser beam generally enters the optical fiber at a converging angle as small as possible such that the core radius of the optical fiber is equal to the input-end face beam radius that is a beam radius on an input end face. In addition, in a case where a plurality of laser beams are simultaneously coupled, it is common to cause the laser beams to enter the optical fiber such that the laser beams match as much as possible in terms of both the converging angles and input-end face beam radii of incoming beams, in which case the best beam quality of the beam to be emitted from the optical fiber is achieved.

Meanwhile, in the present embodiment, as described above, the two laser beams 12 and 22 having different converging angles or beam radii enter the optical fiber 51 so as to modulate beam quality. Under the above-described entry conditions, when a component deriving from the laser beam 12 is compared with a component deriving from the laser beam 22 regarding a laser beam to be emitted from the optical fiber 51, the BPP of the component deriving from the laser beam 22 is equal to or greater than the BPP of the component deriving from the laser beam 12. In practice, the component deriving from the laser beam 12 and the component deriving from the laser beam 22 are emitted from the optical fiber 51 as the single outgoing laser beam 32, and the beam quality of the outgoing laser beam 32 from the optical fiber 51 is modulated according to an intensity ratio between the laser beam 12 and the laser beam 22.

In the present embodiment, the output ratio control unit 31 controls the output ratio between the two laser beams 12 and 22 to modulate the beam quality of the beam to be emitted from the optical fiber 51. Examples of a method of controlling the output ratio include a method of inputting different amounts of energy to the first laser light source 11 and the second laser light source 21 and a method of installing an element that attenuates or amplifies energy in a laser propagation optical path.

According to the laser machining apparatus 1001 of the present embodiment, the concentrated light spot diameter of a laser beam incident on the workpiece W can be modulated depending on the workpiece W. Therefore, it is possible to select an appropriate condition according to the thickness or material of the workpiece W and irradiate the workpiece W with a laser beam.

For example, assume that in order to obtain good machining quality in laser machining for cutting a metal plate material, when a relatively thin iron plate having a thickness of 2 mm or less is cut, the workpiece W is irradiated with a laser beam with a spot diameter of about 100 micrometers, and when a relatively thick plate having a thickness of 20 mm or more is cut, the workpiece W is irradiated with a laser beam with a spot diameter of 1200 micrometers or more. In such a case, in order to cause changes in the beam spot diameter as described above in the laser machining apparatus, a method may be used which adopts a variable magnification optical system in a machining head that concentrates a laser beam on a machining target. However, an actual product often has a spot diameter with a variable magnification of about 1 to 4, and thus, there is a problem in that it is difficult to achieve a variable magnification of 4 or more because this involves an excessive increase in the level of difficulty in designing an optical system, weight, size, cost, and the like.

Meanwhile, from the viewpoint of improving laser machining performance, it is desirable that a concentrated light spot diameter on the workpiece W can be modulated in a range from 100 micrometers to 1200 micrometers, that is, about 1 to 12 times. Therefore, even in the case of combining with the variable magnification optical system capable of modulating magnification in a range from one to four times, it is desirable that the BPP of a laser beam can be modulated up to about three times.

In order to triple the BPP, it is conceivable that any of the following methods is used: a method in which the converging angle of a beam that enters the optical fiber 51 is tripled with no change in the input-end face beam radius of the entering beam, a method in which an input-end face beam radius is set to 1/3 of the radius of the core 52 with no change in the converging angle of the beam that enters the optical fiber 51, or a method in which the input-end face beam radius is set to X/3 of the radius of the core 52 while increasing the converging angle of the entering beam by X times (1<X<3).

In addition, in order to control machining quality in laser machining, it is desirable to modulate the BPP of the laser beam in steps of about 10% at minimum. For this reason, it is desirable to cause the laser beam 22 to enter the optical fiber 51 at an entry angle larger than that of the laser beam 12 by 10% or more, or with an input-end face beam radius smaller than that of the laser beam 12 by 10% or more.

In the present embodiment, when the laser beam 12 and the laser beam 22 are equal in wavelength, it is desirable that the laser beam 12 and the laser beam 22 have different polarization states, and when the laser beam 12 and the laser beam 22 differ in wavelength, the polarization states of the laser beam 12 and the laser beam 22 may be different or identical.

In addition, three or more laser beams may be superimposed.

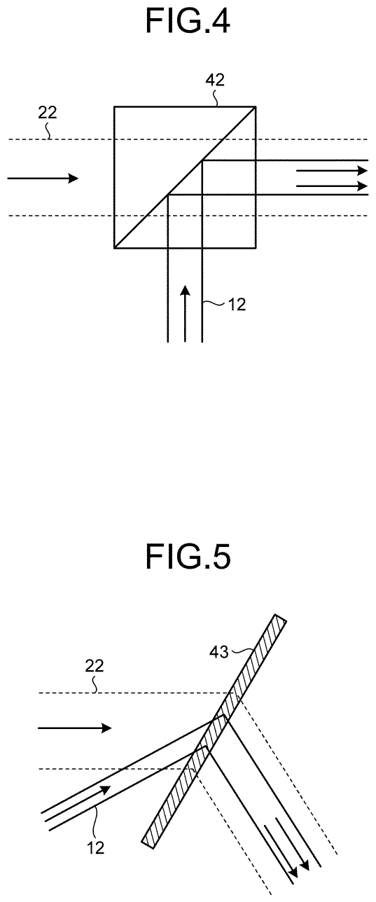

For example, when the polarization states of the laser beams are different from each other, the superimposing optical system 41 may include a polarization beam splitter 42 as illustrated in FIG. 4, and be configured to coaxially superimpose two laser beams with different polarizations. Furthermore, in a case where the wavelengths of the laser beams are different from each other, the superimposing optical system 41 may include a diffraction grating 43 as illustrated in FIG. 5 or a wavelength-selective element such as a dichroic filter, and be configured to coaxially superimpose a plurality of the laser beams with different wavelengths. In addition to these examples, various methods of superimposing a plurality of laser beams can be applied to the present embodiment.

As a technique for obtaining a beam quality modulation effect similar to that of the present embodiment, there is a method in which a laser beam enters an optical fiber at an angle to the axis of the optical fiber as disclosed in, for example, Patent Literature 1. In this case, in order to modulate beam quality, it is necessary to modulate the propagation optical path of the laser beam with respect to the axis of the fiber, and for this purpose, it is necessary to adjust the position of an optical element or a machine component. In order to cause a laser beam to enter an optical fiber, it is necessary to accurately irradiate a fiber core portion having a diameter of about 100 micrometers with a laser beam having the same diameter, that is, a diameter of about 100 micrometers. Therefore, when a method of adjusting the position of an optical element or a machine component is used, a highly accurate control technique is required for a drive unit that performs positioning, a control unit that ensures positional stability after adjustment, and the like, so that the apparatus tends to be expensive. Meanwhile, in the case of using the method described in the present embodiment, since there is no drive unit, it is possible to achieve modulation of beam quality relatively inexpensively and stably.

As described above, according to the first embodiment, since the output ratio between a plurality of laser beams having different propagation characteristics is controlled and the plurality of laser beams having been multiplexed enter the optical fiber, it is possible to control the beam quality of the laser beams without driving a machine component or the like, so that it is possible to achieve modulation of the beam quality relatively inexpensively and stably.

### Second Embodiment

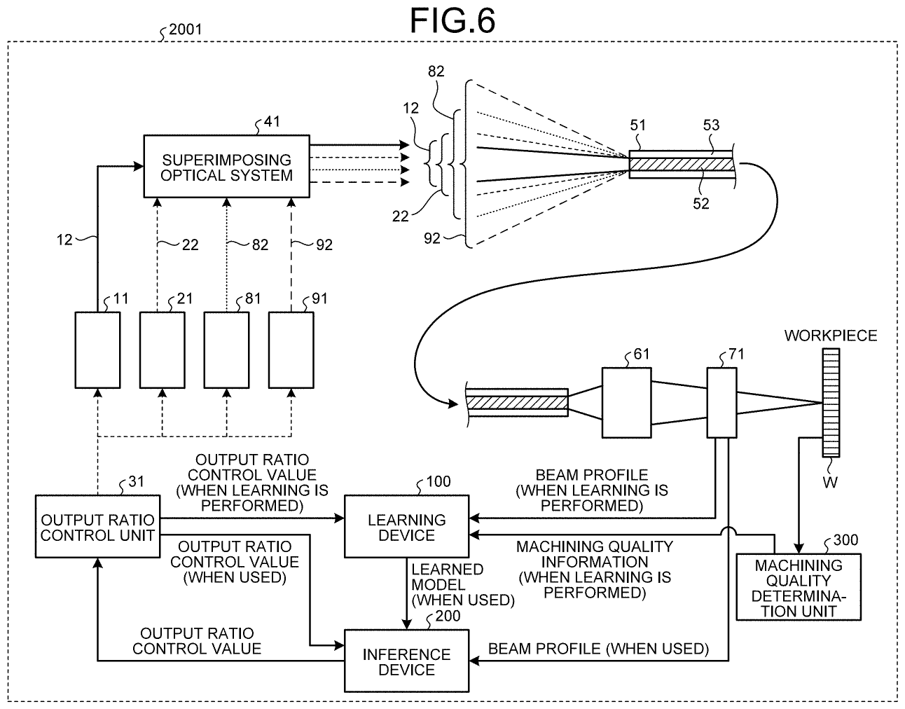

FIG. 6 is a schematic diagram illustrating a configuration of a laser machining apparatus 2001 according to a second embodiment of the present invention. The laser machining apparatus 2001 includes, in addition to the constituent elements of the laser machining apparatus described in the first embodiment, a beam profile detection unit 71, a third laser light source 81 that generates a laser beam 82, a fourth laser light source 91 that generates a laser beam 92, a learning device 100, an inference device 200, and a machining quality determination unit 300. In the present embodiment, the output ratio control unit 31 controls a ratio between outputs of the four laser light sources 11, 21, 81, and 91.

The laser beams 12, 22, 82, and 92 have different propagation characteristics, and the superimposing optical system 41 operates so as to coaxially superimpose these four laser beams. In order to coaxially superimpose the four laser beams, two-beam coupling using polarization may be combined with two-wavelength combination at different wavelengths, or alternatively, four beams with different wavelengths may be wavelength-combined. Alternatively, such a coaxial superimposition method may be combined with another coaxial superimposition method. In addition, the propagation characteristic here refers to a converging angle, a spot diameter, a beam profile, a BPP, or a wavelength of a beam condensed by a common optical system.

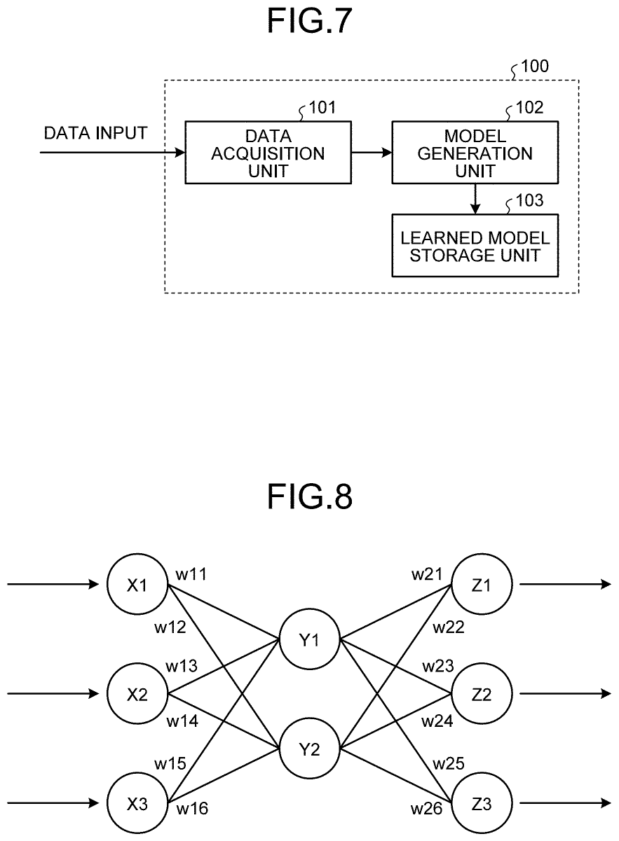

FIG. 7 is an internal configuration diagram of the learning device 100. The learning device 100 includes a data acquisition unit 101, a model generation unit 102, and a learned model storage unit 103.

The data acquisition unit 101 acquires, as training data, an output ratio control value, a beam profile, and machining quality information. The output ratio control value is output from the output ratio control unit 31 of the laser machining apparatus 2001. The beam profile is output from the beam profile detection unit 71. The machining quality information is output from the machining quality determination unit 300. The beam profile here refers to data including any one or more of a beam spot diameter, an intensity distribution, and an angle distribution of a laser beam to be applied to the workpiece W.

The model generation unit 102 learns an output ratio control value with which good machining quality can be obtained, on the basis of training data created on the basis of a combination of the output ratio control value, the beam profile, and the machining quality information output from the data acquisition unit 101. That is, the model generation unit 102 generates a learned model for estimating an output ratio control value with which good machining quality can be obtained, from the output ratio control value, the beam profile, and the machining quality information of the laser machining apparatus 2001. Here, the training data refer to data in which the output ratio control value, the beam profile, and the machining quality information are associated with each other.

Note that the learning device 100 and the inference device 200 are used to learn an output ratio control value with which good machining quality can be obtained in the laser machining apparatus 2001, but the learning device 100 and the inference device 200 may be, for example, devices provided separately from the laser machining apparatus, and be connected to the laser machining apparatus via a network. In addition, the learning device and the inference device may be built into the laser machining apparatus. Furthermore, the learning device and the inference device may be located on a cloud server.

A known algorithm such as an algorithm to be used in supervised learning or reinforcement learning can be used as a learning algorithm by the model generation unit 102. As an example, a case where a neural network is applied will be described. For example, the model generation unit 102 learns an output ratio control value with which good machining quality can be obtained, by so-called supervised learning according to a neural network model. Here, the supervised learning refers to a model in which a large number of data sets of certain inputs and results (labels) are given to a learning device to learn features in these training data, and a result is estimated from an input.

The neural network includes an input layer including a plurality of neurons, an intermediate layer (hidden layer) including a plurality of neurons, and an output layer including a plurality of neurons. The neural network, may include a single intermediate layer, or may include two or more intermediate layers.

For example, in the case of a three-layer neural network as illustrated in FIG. 8, the neural network includes an input layer (X1, X2, X3) with three neurons, an intermediate layer (Y1, Y2) with two neurons, and an output layer (Z1, Z2, Z3) with three neurons. The input layer (X1, X2, X3) is connected to the intermediate layer (Y1, Y2), and the intermediate layer (Y1, Y2) is connected to the output layer (Z1, Z2, Z3). Note that although FIG. 8 shows an example of a neural network including a single intermediate layer, two or more intermediate layers may be provided.

When a plurality of inputs are provided to the input layer (X1, X2, X3), values of the inputs are multiplied by weights w11 to w16 and input to the intermediate layer (Y1-Y2), and the results are further multiplied by weights w21 to w26 and output from the output layer (Z1-Z3) . The output results vary depending on the values of the weights w11 to w16 and w21 to w26.

In the present application, the neural network learns an output ratio control value with which good machining quality can be obtained, by so-called supervised learning according to training data created based on the combination of the output ratio control value, the beam profile, and the machining quality information acquired by the data acquisition unit 101.

That is, the neural network performs learning by adjusting the weights w11 to w16 and w21 to w26 such that results to be output from the output layer in response to the output ratio control value and the beam profile input to the input layer approach good machining quality.

The model generation unit 102 generates a learned model by performing learning as described above, and outputs the learned model.

The learned model storage unit 103 stores the learned model output from the model generation unit 102.

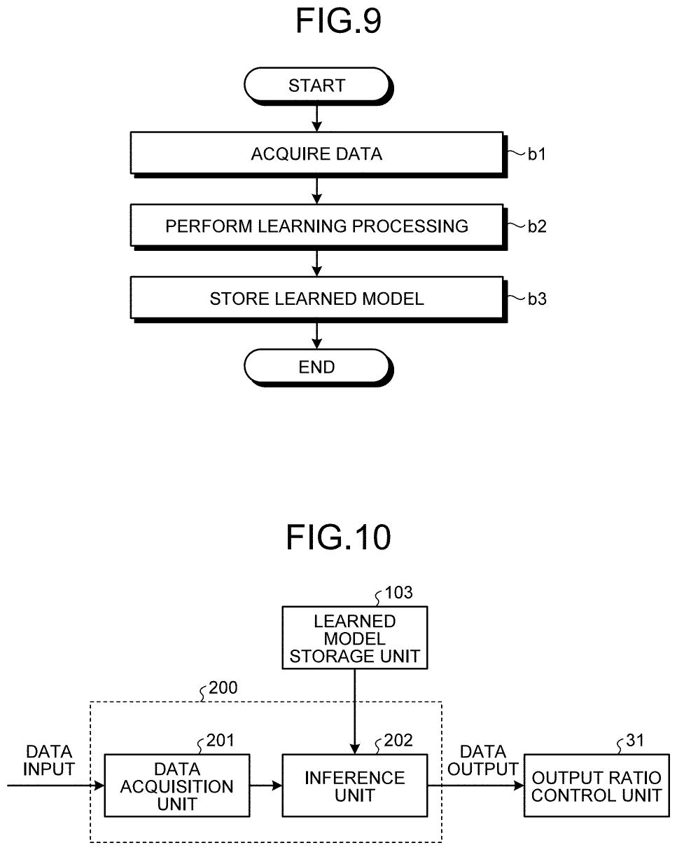

Next, learning processing to be performed by the learning device 100 will be described with reference to FIG. 9. FIG. 9 is a process drawing regarding learning processing to be performed by the learning device 100.

In step b1, the data acquisition unit 101 acquires an output ratio control value, a beam profile, and machining quality information. Note that although the output ratio control value, the beam profile, and the machining quality information are assumed to be simultaneously acquired, the output ratio control value, the beam profile, and the machining quality information just need to be input in association with each other, and data on the output ratio control value, the beam profile, and the machining quality information may be acquired at different timings.

In step b2, the model generation unit 102 generates a learned model by learning an output ratio control value with which good machining quality can be obtained, by so-called supervised learning according to training data created based on a combination of the output ratio control value, the beam profile, and the machining quality information acquired by the data acquisition unit 101, and.

In step b3, the learned model storage unit 103 stores the learned model generated by the model generation unit 102.

FIG. 10 is a diagram illustrating an internal configuration of the inference device 200. The inference device 200 includes a data acquisition unit 201 and an inference unit 202.

The data acquisition unit 201 acquires an output ratio control value and a beam profile.

The inference unit 202 infers an output ratio control value with which good machining quality can be obtained, to be obtained by use of the learned model. That is, by inputting the output ratio control value and the beam profile acquired by the data acquisition unit 201 to the learned model, it is possible to output an output ratio control value with which good machining quality can be obtained that has been inferred from the output ratio control value and the beam profile.

Note that although it has been described, in the present embodiment, that an output ratio control value with which good machining quality can be obtained is output by use of the learned model learned by the model generation unit 102 of the laser machining apparatus 2001, a learned model may be acquired from an external device such as another laser machining apparatus such that an output ratio control value with which good machining quality can be obtained is output based on the learned model.

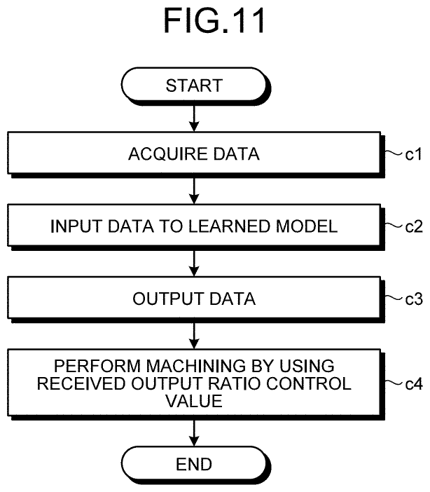

Next, processing for obtaining an output ratio control value with which good machining quality can be obtained to be performed by use of the inference device 200 will be described with reference to FIG. 11.

In step c1, the data acquisition unit 201 acquires an output ratio control value and a beam profile.

In step c2, the inference unit 202 inputs the output ratio control value and the beam profile to the learned model stored in the learned model storage unit 103, and obtains an output ratio control value with which good machining quality can be obtained.

In step c3, the inference unit 202 outputs, to the laser machining apparatus, the output ratio control value with which good machining quality can be obtained that has been obtained by use of the learned model.

In step c4, the laser machining apparatus 2001 adjusts the output ratio between the laser beams 12, 22, 82, and 92 by using the output ratio control value with which good machining quality can be obtained that has been output, and performs machining. As a result, good machining quality can be obtained.

Note that, the case where supervised learning is applied as a learning algorithm to be used by the model generation unit 102 has been described in the present embodiment, but the learning algorithm is not limited thereto. Not only supervised learning, but also reinforcement learning, semi-supervised learning, or the like can be applied as the learning algorithm.

In addition, the model generation unit 102 may learn an output ratio control value with which good machining quality can be obtained, according to training data created for a plurality of laser machining apparatuses. Note that the model generation unit 102 may acquire training data from a plurality of laser machining apparatuses used in the same area, or may learn an output ratio control value with which good machining quality can be obtained by using training data collected from a plurality of laser machining apparatuses operating independently in different areas. In addition, a laser machining apparatus from which training data are collected can be added to or removed from the plurality of laser machining apparatuses in the course of a learning process. Furthermore, a learning device that has learned an output ratio control value with which good machining quality can be obtained for a certain laser machining apparatus may be applied to another laser machining apparatus, and an output ratio control value with which good machining quality can be obtained for the other laser machining apparatus may be relearned and updated.

Furthermore, deep learning, in which extraction of a feature amount itself is learned, can also be used as the learning algorithm by the model generation unit 102. Alternatively, machine learning may be performed according to another known method such as genetic programming, function logic programming, or a support vector machine.

Moreover, the example in which the output ratio between the four laser beams is adjusted has been described in the present embodiment, but actually, the present embodiment can be applied to a case where laser beams having different propagation characteristics are used and the number of the laser beams is any number equal to or greater than 2.

Furthermore, a beam profile has been cited as an example of acquired data in the present embodiment, but the shape of the machined workpiece, a sound signal generated during machining, an optical signal, or the like may be acquired and used instead of the beam profile.

In addition, it is also possible to improve the accuracy of inference by acquiring and learning data on the material or thickness of the workpiece in addition to the acquired data exemplified above.

According to the second embodiment, since an output ratio with which good machining quality can be obtained is learned and an output ratio is controlled on the basis of the learned output ratio, machining with good machining quality can be achieved.

The configurations described in the above embodiments show examples of the subject matter of the present disclosure, and can be combined with another known technique. Furthermore, it is also possible to partially omit or change the configurations without departing from the scope of the present disclosure.

### REFERENCE SIGNS LIST

11 first laser light source; 12 first laser beam; 21 second laser light source; 22 second laser beam; 31 output ratio control unit; 32 outgoing laser beam; 41 superimposing optical system; 42 polarization beam splitter; 43 diffraction grating; 51 optical fiber; 52 core; 53 cladding; 61 condensing optical system; 71 beam profile detection unit; 81 third laser light source; 82,92 laser beam; 91 fourth laser light source; 100 learning device; 101 data acquisition unit; 102 model generation unit; 103 learned model storage unit; 200 inference device; 201 data acquisition unit; 202 inference unit; 300 machining quality determination unit; 1001, 2001 laser machining apparatus; W workpiece.

1. A laser machining apparatus comprising:
a first laser light source to generate a first laser beam;
a second laser light source to generate a second laser beam having propagation characteristics different from propagation characteristics of the first laser beam;
an output ratio controller to change an output ratio that is a ratio between an output of the first laser beam and an output of the second laser beam;
a multiplexing optical system to multiplex the first laser beam and the second laser beam;
an optical fiber including a core and a cladding, the optical fiber having an entrance and an exit, the first laser beam and the second laser beam being input to the entrance after passing through the multiplexing optical system, the first laser beam and the second laser beam being emitted from the exit, beam propagation characteristics of a combined laser beam at the exit varying depending on the output ratio, the combined laser beam being a laser beam obtained by combination of the first laser beam and the second laser beam; and
a condensing optical system to perform machining of a workpiece by concentrating, on the workpiece, the beam emitted from the optical fiber, wherein
the propagation characteristics are a converging angle and a beam radius of a beam that enters the optical fiber.

2. The laser machining apparatus according to claim 1, wherein
the multiplexing optical system coaxially superimposes the first laser beam and the second laser beam.

3. The laser machining apparatus according to claim 1, wherein
the first laser beam and the second laser beam enter the optical fiber at different entry angles, and
an entry angle of the second laser beam is larger than an entry angle of the first laser beam by 10% or more.

4. The laser machining apparatus according to claim 1, wherein
the first laser beam and the second laser beam enter the optical fiber with different beam diameters, and
an incoming beam diameter of the second laser beam is smaller than an incoming beam diameter of the first laser beam by 10% or more.

5. The laser machining apparatus according to claim 1, wherein
the optical fiber includes a single core and a single cladding.

6. The laser machining apparatus according to claim 1, wherein
the multiplexing optical system performs polarization coupling of the first laser beam and the second laser beam by means of a polarization-selective element.

7. The laser machining apparatus according to claim 1, wherein
the first laser beam and the second laser beam are equal in wavelength.

8. The laser machining apparatus according to claim 1, wherein
the multiplexing optical system superimposes the first laser beam and the second laser beam by means of a wavelength-selective element.

9. The laser machining apparatus according to claim 1, comprising:
a learning device including:
data acquisition circuitry to acquire training data including an output ratio control value output from the output ratio controller, a beam profile of a laser beam after passing through the condensing optical system, and quality information on a machining result; and
a model generator to generate a learned model for estimating an output ratio control value that allows the quality information to indicate good quality, by using the training data.

10. The laser machining apparatus according to claim 1, comprising:
an inference device including:
data acquisition circuitry to acquire an output ratio control value output from the output ratio controller and a beam profile of a laser beam after passing through the condensing optical system;
machining quality determination circuitry to acquire machining quality information; and
inference circuitry to output an output ratio control value that allows the machining quality information to indicate good quality, based on the output ratio control value and the beam profile input from the data acquisition circuitry by using a learned model generated by machine learning for estimating an output ratio control value that allows the machining quality information to indicate good quality from the output ratio control value, the beam profile, and the machining quality information.

11. The laser machining apparatus according to claim 1, wherein
an upper limit of a value of a beam parameter product of the combined laser beam is at least three times a lower limit, the beam parameter product being capable of being modulated.

12. The laser machining apparatus according to claim 1, wherein
the beam emitted from the optical fiber is concentrated on the workpiece with a spot diameter that is adjustable within a range of at least 100 micrometers to 1200 micrometers.
